(19) United States
(12) Patent Application Publication
(10) Pub. No.: US 2013/0337250 A1
(43) Pub. Date: Dec. 19, 2013

(54) MODIFIED PERFLUOROPOLYMER MATERIAL

(71) Applicants: Richard J. Austin, Clifton Park, NY (US); Hua Fan, Windham, NH (US); Michael J. Lussier, Bedford, NH (US); William E. Noonan, Saratoga, NY (US)

(72) Inventors: Richard J. Austin, Clifton Park, NY (US); Hua Fan, Windham, NH (US); Michael J. Lussier, Bedford, NH (US); William E. Noonan, Saratoga, NY (US)

(21) Appl. No.: 13/906,097

(22) Filed: May 30, 2013

Related U.S. Application Data
(60) Provisional application No. 61/653,319, filed on May 30, 2012.

(30) Foreign Application Priority Data
Sep. 18, 2012 (JP) 2012-204917

(51) Int. Cl. C09J 7/04

(52) U.S. Cl. CPC C09J 7/048
USPC 428/219; 442/71; 428/354; 427/207.1

(57) ABSTRACT

An improved perfluoropolymer composite that uses a blend of a perfluoropolymer (such as PTFE) and a silicone polymer. By coating a substrate, such as glass fiber fabric, with a blend of a perfluoropolymer and a silicone polymer, an adhesive layer can be bonded either directly to the surface of the perfluoropolymer composite or to a perfluoropolymer composite that has been primed without the need to have otherwise treated the perfluoropolymer surface, such as either by etching or by the deposition of an intermediate coating containing colloidal silica or other similar agents, to make the surface bondable.

The present application claims priority from U.S. Provisional Patent Application No. 61/653,319, filed May 30, 2012, and Japanese Patent Application No. 2012-204917, filed Sep. 18, 2012, both entitled “Modified Perfluoropolymer Material,” and both naming inventors Richard J. Austin, Hua Fan, Michael J. Lussier and William E. Noonan which applications are incorporated by reference herein in their entirety.

### FIELD OF THE DISCLOSURE

This disclosure, in general, relates to elastomer modified perfluoropolymer materials, and in particular to the use of a modified perfluoropolymer material as a fabric coating or as a film so that an adhesive layer can be deposited onto the modified perfluoropolymer material without requiring etching or other additional surface treatment of the perfluoropolymer surface.

### BACKGROUND

Fabric reinforced polytetrafluoroethylene (PTFE) composites are employed in a variety of industries. Fabric reinforced PTFE composites typically include a substrate material, such as a glass fabric, coated with one or more layers having PTFE as the primary polymeric constituent. In general, such composites are known to be resistant to the accumulation of dirt and grime and have a low coefficient of friction. Conventional reinforced PTFE composites are commonly used in applications where it is desirable to bond the PTFE coated substrate to another material. Unfortunately, the same qualities that give rise to the desirable properties of PTFE composites also make it very difficult to bond an adhesive layer to the PTFE coating.

As a result, the PTFE coating has to be treated to make the surface bondable and thus enhance adhesion. The most common surface treatment is a chemical etching using various sodium-containing compounds such as sodium naphthalene or sodium ammonia. Chemical etching, however, is expensive and environmentally undesirable, and the etchant chemicals themselves are highly hazardous. Although other surface treatment methods are known, including enhancing adhesion by plasma and ion beam treatments and the use of intermediate layers or coatings, with such coating often containing colloidal silica (inorganic silicone dioxide) suspended in a melt processable fluoropolymer dispersion of either FEP or PFA, these methods are often not as effective as sodium etching and also require additional expense in both time and in materials and equipment.

As such, an improved perfluoropolymer composite would be desirable.

### SUMMARY OF THE INVENTION

A preferred embodiment of the present invention is directed to an improved perfluoropolymer composite which uses a homogeneous blend of a perfluoropolymer (such as PTFE) and a silicone polymer. By coating a substrate, such as glass fiber fabric, with a blend of a perfluoropolymer and a silicone polymer as described below, an adhesive layer can be bonded either directly to the surface of the perfluoropolymer composite or to a perfluoropolymer composite (homogeneous blend) that has been primed with a commercially available prime coating without the need to have otherwise treated the perfluoropolymer surface, such as either by etching or by the deposition of an intermediate coating containing colloidal silica (inorganic silicone dioxide) or other similar agents that been bonded to the surface of the fluoropolymer through the use of a melt processable fluoropolymer such as FEP or PFA to make the surface bondable.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

The present disclosure may be better understood, and its numerous features and advantages made apparent to those skilled in the art by referencing the accompanying drawings.

FIG. 1 shows an example of a prior art PTFE coated substrate.

FIG. 2 illustrates a surface treatment applied to the PTFE coated substrate of FIG. 1.

FIG. 3 shows the PTFE coated substrate of FIG. 1 after surface treatment and the addition of an adhesive layer to the treated surface.

FIG. 4 is a flow chart showing the steps in a method of producing a reinforced perfluoropolymer composite according to a preferred embodiment of the present invention.

FIG. 5 shows an exemplary reinforced perfluoropolymer composite according to a preferred embodiment of the present invention.

FIG. 6 shows an exemplary reinforced perfluoropolymer composite according to another preferred embodiment of the present invention.

FIG. 7 shows an unsupported sheet material formed of a blend of perfluoropolymer and silicone polymer according to a preferred embodiment of the present invention.

The accompanying drawings are not intended to be drawn to scale. In the drawings, each identical or nearly identical component that is illustrated in various figures is represented by a like numeral. For purposes of clarity, not every component may be labeled in every drawing.

### DESCRIPTION OF THE DRAWINGS

PTFE coated substrates, such as PTFE coated glass fabric, are commonly used in applications where it is desirable to bond the PTFE coated substrate to another material. One typical example would be PTFE coated fiberglass tape used as a release surface on heat sealers and other packaging equipment. During the manufacturing process, the substrate, such as the glass fiber, is first coated with one or more layers of PTFE.

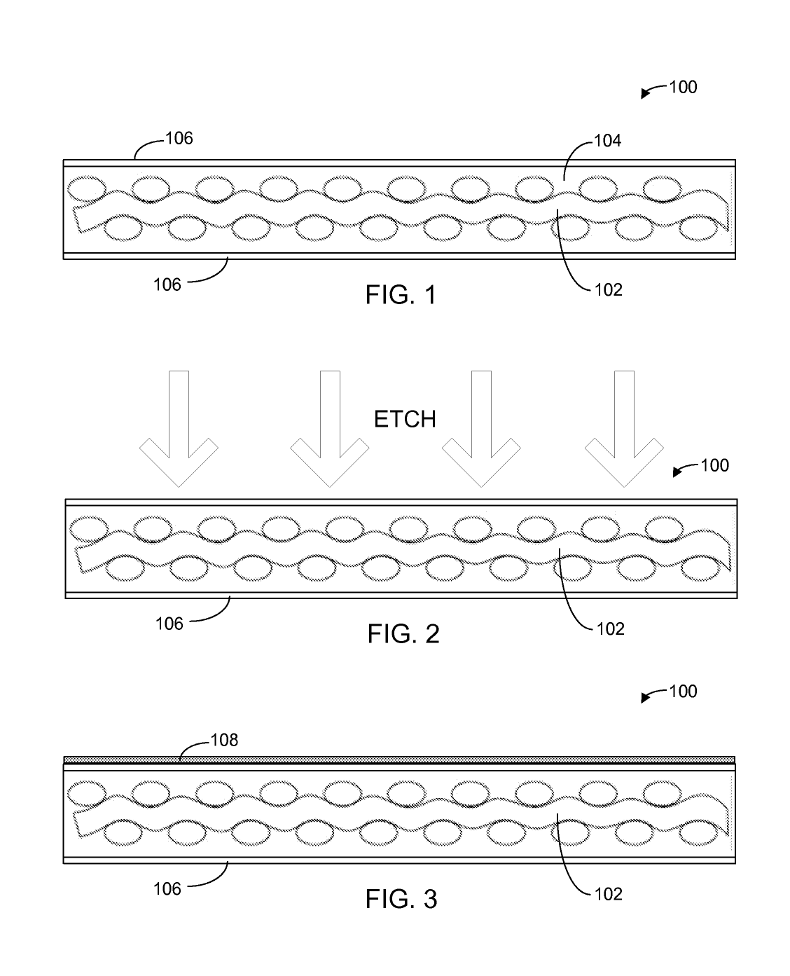

FIG. 1 shows an example of a prior art PTFE coated substrate 100. Substrate 102 is typically a film or a glass fabric having a thermal stability sufficient to tolerate PTFE processing temperatures of around 370° C. A PTFE coating 104 is applied to both sides of the substrate, typically in multiple passes. Finally, a PTFE film is laminated onto both sides of the coated substrate. A film typically has a more uniform consistency than a coating and lower variability in properties. An example of a film includes a skived film, a cast film, or an extruded film.

An adhesive layer must then be deposited onto one surface of the coated fabric in order to attach the PTFE coated substrate to another surface. This can be difficult because PTFE has an extremely low surface energy (about 18 mN/m). While this low surface energy contributes greatly to many of the desirable characteristics of PTFE, such as its lubricity and its extremely low coefficient of friction, it also means that most adhesives (which typically have surface energies greater than 30 mN/m) will not adhere well to a PTFE surface.

As a result, the PTFE coating has to be treated to enhance adhesion. FIG. 2 schematically illustrates a surface treatment applied to one major surface of the PTFE coated substrate of FIG. 1. The most common surface treatment is a chemical etching using various sodium-containing compounds such as sodium naphthalene or sodium ammonia. During the etching process, the sodium reacts with the PTFE to extract fluorine atoms at the surface and form a carbonaceous layer, which is compatible with adhesives. Once the surface has been etched, an adhesive such as a silicone adhesive including a blend of silicone rubber and silicone resin will adequately bond to the etched surface, as shown in FIG. 3. Typically, a primer coating is applied to the etched surface to promote adhesion before the silicone adhesive is applied.

This type of etching process, however, is expensive, time-consuming, and requires the use of highly hazardous etchants and the disposal of large amounts of waste fluid. Extended exposure to the sodium-containing etchants will also result in a degradation of the PTFE substrate surface. Further, once etching has been completed, heating and UV exposure will degrade the treated surface, causing the surface energy and co-efficient of friction values to return to their pre-treatment states (which will typically result in failure of the adhesion).

Although other surface treatment methods are known, including plasma and ion beam treatments, but these methods are not as effective as sodium etching and also require additional expense in both time and in materials and equipment. As used herein, the term “etching” will be used to describe any method of defluorination of the surface of a perfluoropolymer such as PTFE, whether by wet chemical etching, plasma or ion processing, or by any other process.

It is also known to use intermediate layers or coatings containing colloidal silica suspended in a melt processable fluoropolymer dispersion of either FEP or PFA as a surface treatment to make the perfluoropolymer surface bondable. Essentially, this type of surface treatment has relatively large silica particles embedded in a melt processable coating. This produces a rougher, more bondable surface that can be adequate for bonding an adhesive layer to the surface, but again the use of such surface treatments adds additional processing steps and expense. The invention described herein eliminates the need to etch the surface or to apply a melt processable fluoropolymer dispersion containing colloidal silicone (inorganic silicone dioxide) or other similar agents.

The perfluoropolymer surface can also be coated with various commercially available primers to promote adhesion, but typically these adhesion promoting layers are used in addition to the etching treatments described above. For example, after the surface is been treated to make it bondable (by either etching or applying a coating of a FEP or PFE dispersion containing colloidal silica), a layer of an adhesion-promoting primer such as a liquid silicone is deposited onto the bondable surface. The silicone adhesive layer is then deposited onto the primed surface.

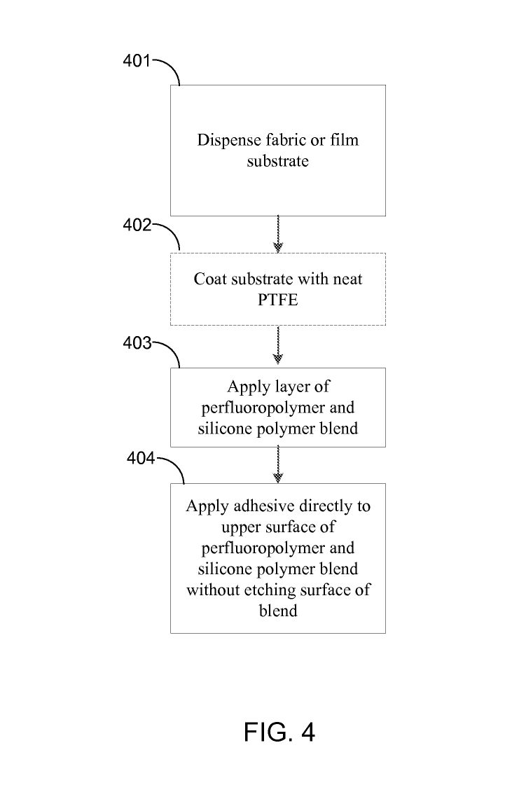

FIG. 4 is a flow chart showing the steps in a method of producing a reinforced perfluoropolymer composite according to a preferred embodiment of the present invention. In step 401, a fabric or film substrate is provided, as described above. In optional step 402, the substrate can be coated with a layer of neat PTFE (described in detail below).

In step 403, instead of a pure PTFE coating as an outer coating, a substrate is instead coated with a homogenous blend of a perfluoropolymer (such as PTFE) and a silicone polymer. The silicone polymer forms about 2 wt % to about 30 wt % of the blend. Such a blend of a perfluoropolymer and a silicone polymer is described in U.S. Pat. App. 2010/0159223 by Keese et al., for “Modified Perfluoropolymer Sheet Material and Methods for Making Same,” which is assigned to the assignee of the present invention and hereby incorporated by reference. Applicants have discovered that this type of perfluoropolymer and silicone polymer blend provides all of the advantageous qualities of a PTFE coating, including a low coefficient of friction and excellent heat and wear resistance. Surprisingly, however, such a perfluoropolymer and silicone polymer blend will bond to a silicone adhesive without the use of any etching process or the application of any intermediate layer containing a melt processable fluoropolymer such as FEP or PFA and an inorganic filler such as a colloidal silica (inorganic silicone dioxide). Obviously this provides a significant advantage in terms of manufacturing ease and cost when used in the production of coated substrates such as the coated glass fiber described above.

In an embodiment, the substrate can be coated by way of a polymer dispersion. The dispersion includes a perfluoropolymer and silicone polymer in an amount of 2% to 30% by weight based on the total weight of the solids in the dispersion. The dispersion can be an aqueous dispersion.

The blend preferably includes a fluorinated polymer. The fluorinated polymer can be a homopolymer of fluorine-substituted monomers or a copolymer including at least one fluorine-substituted monomer. Exemplary fluorine substituted monomers include tetrafluoroethylene (TFE), vinylidene fluoride (VF2), hexafluoropropylene (HFP), chlorotrifluoroethylene (CTFE), perfluoroethylvinyl ether (PEVE), perfluoromethylvinyl ether (PMVE), and perfluoropropylvinyl ether (PPVE). Examples of fluorinated polymers include polytetrafluoroethylene (PTFE), perfluoroalkylvinyl ether (PFA), fluorinated ethylene-propylene copolymer (FEP), ethylene tetrafluoroethylene copolymer (ETFE), polyvinylidene fluoride (PVDF), polychlorotrifluoroethylene (PCTFE), and TFE copolymers with VF2 or HFP. In particular, the blend includes a perfluoropolymer, such as PTFE, polyhexafluoropropylene (HFP), fluorinated ethylene propylene (FEP), perfluoroalkylvinyl (PFA), or any combination thereof. In a particular example, the perfluoropolymer includes polytetrafluoroethylene (PTFE). In some preferred embodiments, the perfluoropolymer is derived from a dispersion, such as an aqueous dispersion.

The silicone polymer can include a polysiloxane. For example, the silicone polymer can include a polyalkylsiloxane, a phenylsilicone, a fluorosilicone, or any combination thereof. In an example, a polyalkysiloxane includes a polydimethylsiloxane, a polydipropylsiloxane, a polymethylpropylsiloxane, or any combination thereof. In particular, the silicone polymer can be derived from an aqueous dispersion of precured silicone polymers. In an example, the silicone polymer can be derived from an aqueous dispersion and can include precured silicone with terminal end groups that undergo condensation reaction during drying. In particular, the silicone polymer can be derived from an aqueous dispersion of precured silicone with terminal groups or additives, such as cross-linkers, that undergo a condensation reaction when dried. For example, the silicone polymer can be selected from a silicone polymer dispersion such as WACKER CT27E silicone rubber dispersion (commercially available from Wacker-Chemie GmbH, Munich, Germany), 84 ADDITIVE (commercially available from Dow Corning) or POLON MF 56 (commercially available from Shin-Etsu Chemical Co., Ltd., Tokyo, Japan).

The blend can include silicone polymer in an amount in a range of 2 wt % to 30 wt % based on the total weight of the fused blend. For example, the blend can include silicone polymer in an amount in a range of 5 wt % to 30 wt %, such as a range of 10 wt % to 30 wt %, or even a range of 15 wt % to 20 wt %. In addition, the blend can include fluoropolymer, such as perfluoropolymer, in an amount in a range of 70 wt % to 98 wt %, such as a range of 75 wt % to 90 wt %, or even a range of 80 wt % to 85 wt %.

Optionally, the blend can include fillers. For example, the blend can include fillers, light stabilizers, pigments, and bonding aids. Exemplary fillers include talc, silica, and calcium carbonate. Exemplary light absorbing additives and pigments include TiO2, Fe2O3, carbon black, and calcined mixed metal oxides. Such fillers can be included in the blend in an amount not greater than 60 wt %, such as not greater than 40 wt %, not greater than 15 wt %, or even not greater than 5 wt %.

A preferred substrate for use with embodiments of the present invention can be a woven or nonwoven fibrous substrate. For example, the fibrous substrate can be a woven fabric or an intermeshing of random fibrous strands. In one exemplary embodiment, the fabric is a woven glass fabric. In other embodiments, the substrate can include carbon fiber, polyaramide, a mesh of ceramic, plastic, or metallic material or sheets of composite materials, or other thermally stable fabrics. Alternatively, the substrate can take the form of a sheet. Embodiments can include high melting point thermoplastics, such as thermoplastic polyimides, polyether-ether ketones, polyaryl ketones, polyphenylene sulfide, and polyetherimides; thermosetting plastics, particularly of the high temperature capable thermosetting resins, such as polyimides; coated or laminated textiles based on the above thermoplastics or similar thermally stable resins and thermally stable reinforcements such as fiberglass, graphite, and polyaramid; plastic coated metal foil; and metallized or metal foil laminated plastic films. In addition, exemplary embodiments include woven and non-woven materials formed of fibers selected from aramid, fluorinated polymer, fiberglass, graphite, polyimide, polyphenylene sulfide, polyketones, polyesters, or a combination thereof. In particular, the fibrous substrate includes a fiberglass reinforcement that has been cleaned or pretreated with heat. Alternatively, the fibrous substrate can be a coated fiberglass substrate. In a particular example, each of the fibers of the fiberglass can be individually coated with a polymeric coating, such as a fluoropolymer coating, for example, PTFE. The substrate can have a total thickness of at least 1.5 mils, such as at least 2.0 mils, at least 3.5 mils, at least 5.0 mils, or even at least 9 mils.

The fluoropolymer coating 104 can be applied in an amount of at least 1.5 osy. Given that a woven fibrous reinforcement can undulate, the amount of the layer is provided in weight per area (ounces per square yard (osy)). For example, the layer can be applied in an amount of at least 0.5 osy, such as at least 1.5 osy, at least 1.8 osy, as at least 2.0 osy, at least 4.0 osy, at least 4.5 osy, or even at least 6.0 osy. In general, the coating is applied in an amount not greater than 5.0 osy. Depending upon the coating applied, the total weight of the coated fabric can be at least 2.8 osy, such as at least 4.0 osy, at least 4.5 osy, or even at least 6.0 osy.

In a preferred embodiment, the blend used to coat the substrate has a surface energy of at least 30 mN/m, at least 33 mN/m, at least 35 mN/m, at least 40 mN/m, or even more preferably a surface energy of at least 50 mN/m. This is comparable to the surface energy of etched PTFE, which will typically be approximately 32 to 44 mN/m, depending upon the type of etch used and the precise conditions.

Referring again to FIG. 4, once the substrate has been coated with an outer layer of perfluoropolymer and silicone polymer blend (on at least one side) a layer of silicone adhesive can be directly deposited onto the blend surface, in step 404, without a surface etching step or the application of a surface treatment containing colloidal silica (inorganic silicone dioxide) suspended in a melt processable fluoropolymer dispersion of either FEP or PFA. Although much of the discussion herein is directed at depositing an adhesive layer, in some embodiments of the present invention, a layer of a silicone polymer other than an adhesive could be directly deposited to the blend surface. In some preferred embodiments, a commercially available primer can be applied to the blend surface before the adhesive layer (or other silicone polymer layer) is deposited. Commercially available primer coatings include products sold under the trade name SILOFF by Dow Corning and products sold under the trade name SILFORCE by Momentive Performance Materials. As used herein, any reference to an adhesive layer being deposited “directly” onto a surface will be understood to also apply to the deposition of the adhesive layer onto a primed surface as long as the surface has not been subjected to an etching step.

As discussed above, most adhesives, including silicone adhesives, have surface energies that are at least 30 mN/m. In terms of the performance of an adhesive, it is the difference in surface energies that is most significant. Ideally, a substrate surface should have a surface energy that is 7 to 10 mN/m higher than the surface energy of the adhesive. This will allow adequate “wetting” of the substrate surface with the adhesive and thus produces a stronger bond.

Applicants have discovered that when using the perfluoropolymer and silicone polymer blend according to embodiments of the present invention, the adhesion between the blend surface and a silicone polymer will be even stronger than predicted using surface energy alone. This is because the silicone polymer in the blend surface will adhere to the silicone in the deposited layer, producing an unexpectedly strong adhesion. As a result, in preferred embodiments, a silicone adhesive (or other silicone polymer) can be bonded directly to the untreated perfluoropolymer and silicone polymer blend. In other words, no surface treatment either by etching or by application of an intermediate adhesion promoting layer is required. In an example, a silicone adhesive will bond directly to a fully fluorinated surface of the perfluoropolymer and silicone polymer blend.

To coat a suitable substrate, such as glass fiber, according to an embodiment of the present invention, a dispersion can be prepared including a blend of perfluoropolymer particles and pre-cured silicone elastomer particles. For example, the dispersion can be an aqueous dispersion. In a particular example, a dispersion of perfluoropolymer, such as PTFE, is mixed with a dispersion of precured silicone polymer. The silicone polymer can form between 2 wt % and 30 wt % based on the solids of the dispersion. For example, the silicone polymer can form 5 wt % to 30 wt % of the solids of the dispersions, such as 10 wt % to 30 wt %, 10 wt % to 25 wt %, or even 15 wt % to 20 wt % of the solids of the dispersion. The perfluoropolymer can form the remainder of the solids of the dispersion. For example, the perfluoropolymer can form 70 wt % to 98 wt % of the solid content of the dispersion, such as 75 wt % to 90 wt % or even 80 wt % to 85 wt % of the solid content of the dispersion. Alternatively, a solid filler can be included in the dispersion. For example, the solid filler can form not greater than 60 wt % of the solids in the dispersion, such as not greater than 40 wt %, not greater than 15 wt %, or not greater than 5 wt %.

The substrate material can be a fibrous substrate and in particular, can be a coated fibrous substrate. In a particular embodiment, the fibrous substrate, such as a fiberglass, can be drawn through an aqueous dispersion including the blend of perfluoropolymer and silicone elastomer. Excess dispersion can be removed using a wiping arrangement, such as a metering bar, a Bird bar, a wire-wound metering bar, a K bar, or other similar equipment or combinations thereof. The substrate material coated with the blended dispersion is then passed through an oven. The oven can be, for example, a three zone tower oven.

In particular, the three zone tower oven can fuse the coated material. For example, the first zone can dry the dispersion at a temperature in a range of 200° F. to 300° F. The second zone can heat the deposited blend to remove surfactants and other additives. In particular, the second zone can heat the deposited blend at a temperature in a range of 500° F. to 600° F. The third zone can be set to fuse the blend, for example, melt the perfluoropolymer, or can be set to form a semi-fused layer. For example, the third zone can be set to a temperature in a range of 680° F. to 700° F. to fuse the material. In another example, the third zone can be set to a temperature in a range of 550° F. to 600° F. to semi-fuse the layer. Alternatively, the coating can be heating in an oven including one zone, two zones, or more. In a particular example, the coating can be dried and sintered in two stages.

Optionally, as shown in FIG. 4, the substrate can be coated with a dispersion of neat perfluoropolymer (absent the silicone) prior to applying the blend as a final perfluoropolymer coating. For example, the substrate material can be drawn through an aqueous dispersion of PTFE and processed as described above. For example, the substrate material can be passed through the emulsion once. In some embodiments, the substrate material can be passed through a second time, or optionally a third time, and fused. Each pass results in additional thickness referred to herein as a pass. Once the neat PTFE coating has been deposited and dried, the blend can be applied over the PTFE in the same fashion as described above. The blend can also be applied in one or more passes, whether it is being applied over a PTFE coating or directly to the substrate.

In some preferred embodiments, the blend can be applied to only one side of the substrate, with the other side coated, for example, with a typical neat PTFE coating. In this case, an adhesive layer will preferably be deposited onto the blend-coated side of the substrate.

Optionally additional layers of other materials can be applied to the substrate. Preferably these other layers are followed by a final blend coating so that an adhesive can be applied without requiring the use of an etch or an additional intermediate adhesion-promoting layer.

To deposit the blended dispersion that includes perfluoropolymer and silicone elastomer, the process can be repeated. For example, the fibrous substrate, such as an uncoated fibrous substrate or the coated fibrous substrate, can be drawn through a bath of aqueous dispersion including the blend of perfluoropolymer and silicone elastomer. Excess dispersion can be removed using a wiping arrangement, such as a metering bar, a Bird bar, a wire-wound metering bar, a K bar, or other similar equipment or combinations thereof. The substrate material coated with the blended dispersion is heated. For example, the dispersion can be heated to dry the dispersion, remove surfactants or other additives and subsequently to melt the perfluoropolymer and cure the precured silicone polymer. In particular, the coated substrate material can pass through a three zone tower oven, including a first zone that dries the dispersion at a temperature in a range of 200° F. to 300° F. A second zone of the oven can remove surfactants and other additives from the deposited blend coating at a temperature in a range of 500° F. to 600° F. The third zone can be set to fuse the blend, for example, melt the perfluoropolymer, or can be set to form a semi-fused layer. For example, the third zone can be set to a temperature in a range of 680° F. to 700° F. to fuse the material. In another example, the third zone can be set to a temperature in a range of 550° F. to 600° F. to semi-fuse the layer. Alternatively, the coating can be heating in an oven including one zone, two zones, or more. In a particular example, the coating can be dried and sintered in two stages.

In an example of a blend-coated substrate having a deposited adhesive layer, a sample of industry-style1080 fiberglass fabric, greige finish, weighing 1.38 ounces per square yard (osy) after heat cleaning, with thickness of 2.1 mils, is coated with a dispersion mixture of an aqueous PTFE dispersion, DuPont TE-3859, and a silicone rubber dispersion, Wacker Silicones Finish CT27E (Wacker Silicones, Adrian, Mich.), by drawing the fabric through the dispersion and wiping excess dispersion from the coated fabric. The dispersion mixture is made by combining by simple stifling about 131 parts by weight (pbw) of the DuPont TE-3859 with about 31 pbw of the Wacker CT27E. The mixture is not reduced with water.

The coating comprises about 80 weight percent of PTFE and 20 weight percent of silicone rubber. After the fabric has been drawn through the dispersion and wiped, it is passed through a three-zone tower oven, which in the first zone dries the dispersion at a temperature in a range of 200° F. to 300° F., in the second zone heats the deposited PTFE resin at a temperature in a range of 500° F. to 600° F., and in the third zone melts the PTFE at a temperature in a range of 680° F. to 700° F. The subsequent total weight of the coated fabric is 4.24 osy and is 3.5 mils thick.

Once the fabric has been coated, a PTFE film can optionally be laminated onto one surface. A film typically has a more uniform consistency than a coating and lower variability in properties. An example of a film includes a skived film, a cast film, or an extruded film.

A layer of adhesive can then be applied to the other surface. A silicone adhesive can be applied to the coated substrate surface by reverse roll coating in which the adhesive coating is metered using the gap between two cylindrical metal rollers. In other embodiments, the adhesive can be deposited by other known methods, including spraying or brush coating. One example of a suitable silicone adhesive for use in preferred embodiments of the present invention would be Dow 7358 adhesive (available commercially from Dow Corning) using 2% benzoyl peroxide as a catalyst.

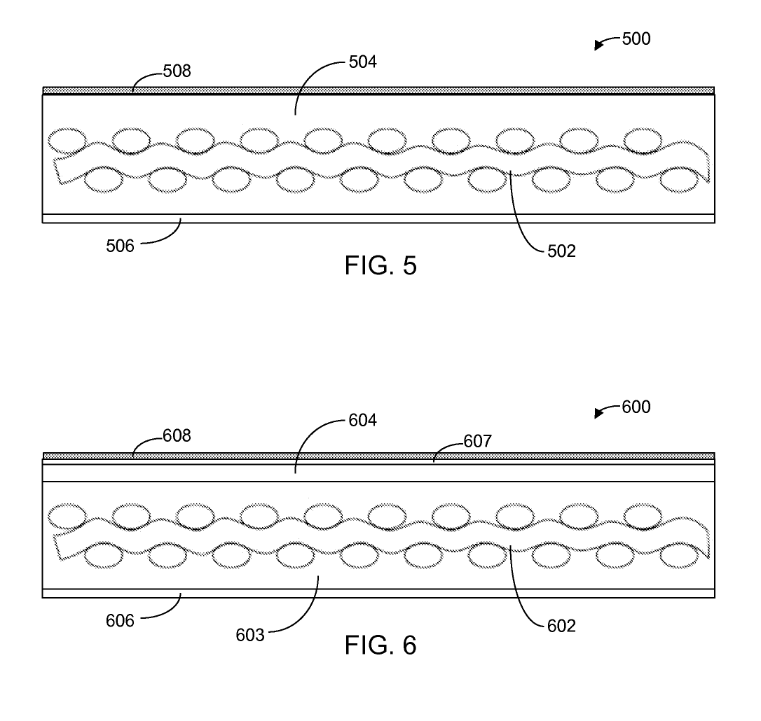

FIG. 5 shows an example of a perfluoropolymer composite 500 according to an embodiment of the present invention in which a substrate 502 has been coated with blend of a perfluoropolymer and a silicone polymer 504 (on both sides of the substrate). A neat PTFE film 506 has been laminated onto one surface of the perfluoropolymer composite, while an adhesive layer 508 has been directly applied to the opposite surface.

FIG. 6 shows an example of a perfluoropolymer composite 600 according to an embodiment of the present invention in which a substrate 602 has first been coated with a dispersion of neat perfluoropolymer 603 (absent the silicone) on both sides of the substrate. A layer of perfluoropolymer and silicone polymer blend has then been applied over the PTFE layer to form an outer perfluoropolymer layer 604. A PTFE film 606 has been laminated onto one surface of the perfluoropolymer composite. On the other side of the coated substrate, a primer layer 607 has been applied to the surface of the perfluoropolymer and silicone polymer blend, and an adhesive layer 608 has been applied over the primer.

Samples prepared according to the methods described above (having a layer of perfluoropolymer and silicone polymer blend applied over a layer of neat PTFE) were tested using an industry standard webbing test to determine how well the adhesive was bonded to the blend surface. To perform a webbing test, a small slit is cut in the blend-coated substrate (also referred to as the backing). The backing is then torn in the direction of the slit. If there is a good bond between the adhesive and the backing, the adhesive will also tear at roughly the same rate. If there is not a good bond, the adhesive will tend to come away from the backing rather than tear. The distance between the furthest point of the backing tear and the furthest point of the adhesive tear (the webbing distance) can give a quantitative assessment of the bond strength between adhesive and backing.

Samples prepared according to the methods described above in which the adhesive was applied to a substrate surface of unprimed silicone polymer blend showed a webbing distance of approximately 0.75 inches, while prior art PTFE samples with etched surfaces (also without a primer coating) showed a webbing distance of approximately 2 inches. When a primer coating was deposited onto the blend-coated substrate before an adhesive was applied, the webbing distance decreased to less than 0.5 inches, which is comparable to the webbing distances for adhesive applied to etched PTFE surfaces with a silicone primer layer. This illustrates that a relatively good bond can be achieved by applying the adhesive layer onto an unprimed blend surface. An even better bond is achieved by applying the adhesive layer to a primed silicone polymer blend surface, but without the undesirable etching step or the application of a coating comprised of a melt processable fluoropolymer such as FEP or PFA with such coating containing an inorganic filler such as colloidal silica (silicon dioxide).

In addition to providing an adequate bond between the coated substrate and an adhesive without the necessity of any type of etching, preferred embodiments of the present invention exhibit an unexpected and desirable resistance to deterioration resulting from heat or UV exposure. When prior-art PTFE coatings are etched, fluorine atoms are extracted from the coating surface, which creates a much more chemically active layer on the coating surface. The defluorination only takes place in a shallow layer at the coating surface. Over time, fluorine atoms from deeper in the sample will tend to migrate toward the defluorinated layer. The speed of this migration is greatly increased by exposure to heat or UV radiation. As the surface molecules are “re-fluorinated,” the PTFE will be returned to its original condition in terms of surface energy and coefficient of friction. As a result, the bond between the coating and the adhesive will weaken and eventually fail.

In contrast, preferred embodiments of the present invention are much more resistant to UV damage. Because no etching or defluorination is required, the bond between the inventive coating and the adhesive will not be weakened by exposure to heat or UV radiation. As a result, a longer shelf life can be expected for embodiments of the present invention with adhesive applied to the blend.

In another preferred embodiment, an adhesive layer can be applied directly to an unsupported sheet of the perfluoropolymer and silicone polymer blend. Such as unsupported sheet is described by U.S. Pat. App. 2010/0159223, which is incorporated by reference. As used herein, the term “sheet” is not meant to imply any particular thickness, and an unsupported sheet according to embodiments of the present invention, for example, could have a thickness of, for example, greater than 3 mils, greater than 5 mils, or greater than 9 mils.

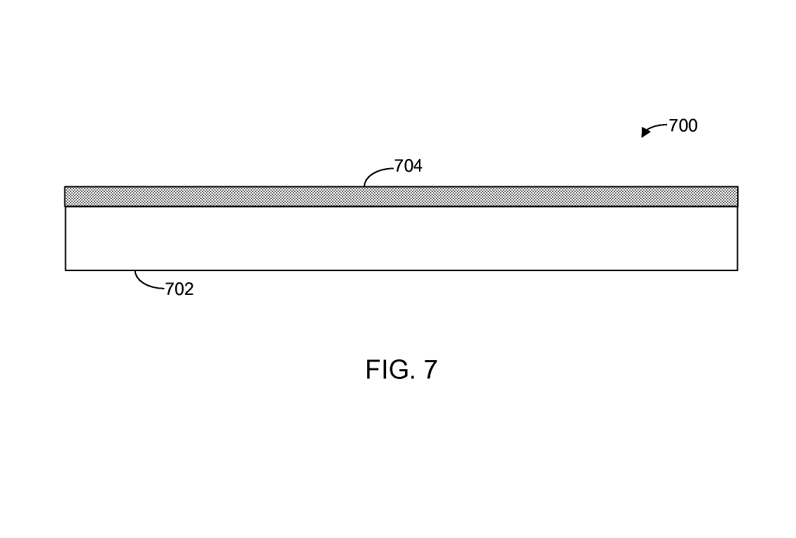

The blend preferably includes the silicone polymer in an amount in a range of 2 wt % to 30 wt %, based on the total weight of solids in the polymer dispersion. For example, the sheet material 700 illustrated in FIG. 7 includes a layer 702 formed of a blend of perfluoropolymer and silicone polymer. As illustrated, the material 700 is free of reinforcement. Alternatively, additional layers can be disposed on either major surface of the layer 702.

To form the sheet material, a dispersion can be prepared including a blend of perfluoropolymer particles and precured silicone elastomer particles. For example, the dispersion can be an aqueous dispersion. In a particular example, a dispersion of perfluoropolymer, such as PTFE, is mixed with a dispersion of precured silicone polymer. The silicone polymer can form between 2 wt % and 30 wt % based on the solids of the dispersion. For example, the silicone polymer can form 5 wt % to 30 wt % of the solids of the dispersions, such as 10 wt % to 30 wt %, 10 wt % to 25 wt %, or even 15 wt % to 20 wt % of the solids of the dispersion. The perfluoropolymer can form the remainder of the solids of the dispersion. For example, the perfluoropolymer can form 70 wt % to 98 wt % of the solid content of the dispersion, such as 75 wt % to 90 wt % or even 80 wt % to 85 wt % of the solid content of the dispersion. Alternatively, a solid filler can be included in the dispersion. For example, the solid filler can form not greater than 60 wt % of the solids in the dispersion, such as not greater than 40 wt %, not greater than 15 wt %, or not greater than 5 wt %.

A carrier can be coated with at least 2.0 osy of a polymer dispersion through the process described above, or through an alternative process such as knife coating, or casting. Excess material can be wiped and the coating dried and sintered or fused. For example, the carrier can be a solid material that can be separable from the sheet material. In such a case, the sheet material including a layer of the blend can be formed by first coating the carrier, drying and sintering the material, and separating the material from the carrier to form a sheet material. In such an example, the sheet material is free of a reinforcement layer.

In a particular example, a carrier material can optionally be passed through an emulsion of perfluoropolymer, such as PTFE, and fused. For example, the carrier material can be passed through the emulsion once. In another example, the carrier material can be passed through a second time, or optionally a third time, and fused. Each pass results in additional thickness referred to herein as a pass. Following the application of the perfluoropolymer layer, if used, the sheet material can be passed through an emulsion including a blend of perfluoropolymer and silicone. The sheet material can be passed through the emulsion of the blend at least once. In particular, the sheet material can be passed through the emulsion of the blend twice or can be passed through the emulsion three or more times. Following coating of the blend over the sheet material, the blend layer can be fused. Alternatively, the blend layer can be semi-fused, as described above. The carrier can then be removed leaving the sheet material unsupported.

In addition, particularly when the outer layer is a semi-fused layer, the sheet material can be pressed or calendered. In an example, the drums of the calender can be set to a temperature in a range of 275° F. to 400° F. and to a pressure between the drums in a range of 500 psi to 4000 psi. Subsequently, the calendered sheet material including the semi-fused layer or layers can be subjected to fusing conditions, such as a temperature within a range of 680° F. to 700° F.

Further, the sheet material can pass through a cooling plenum from which it can be directed to a subsequent dip pan to begin formation of a further layer of film, to a stripping apparatus, or to a roll for storage. In another embodiment, sheets of composite material are formed and subsequently layered over the substrate material. These sheets can be further processed to bond to the substrate material. For example, sheets of material can be laminated to the substrate material.

In a particular example, a semi-fused layer, either the blend layer or an additional layer can be pressed into contact with another semi-fused layer of another sheet material or film. In an example, the construct can be fused to bond the sheet materials or sheet material and film together. For example, an additional semi-fused PTFE outer layer can be pressed or calendered into contact with a semi-fused PTFE layer of a second sheet material or film and subsequently fused. In another example, a semi-fused blend layer can be placed in contact with a semi-fused blend layer or semi-fused perfluoropolymer layer of a second sheet material or film, and subsequently fused.

An adhesive layer 704 can then be applied to the unsupported sheet material as described above. In some embodiments, the sheet material can be coated with a layer of primer before the adhesive layer is applied (but without etching the surface of the sheet material).

Although much of the previous discussion is directed at a perfluoropolymer coating including PTFE along with a silicone polymer, embodiments of the present invention can make use of other fluoropolymers such as hexafluoropropylene (HFP), fluorinated ethylene propylene (FEP), perfluoroalkyl vinyl ether (PFA), or a combination thereof.

As used herein, the terms “over” or “overlie,” when used in relation to location indicate a location relatively closer to an outer surface of the sheet material when moving away from reinforcement material, if any. In similar fashion, when a layer is described as being applied on or over another layer, it is understood that the application could be on either major surface of a substrate without regard to orientation of the substrate, as long as a layer applied on a substrate or a previously applied layer will be closer to an outer surface than the substrate or previously applied layer.

The invention has broad applicability and can provide many benefits as described and shown in the examples above. The embodiments will vary greatly depending upon the specific application, and not every embodiment will provide all of the benefits and meet all of the objectives that are achievable by the invention. Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention. After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present). Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Although the present invention and its advantages have been described in detail, it should be understood that various changes, substitutions and alterations can be made to the embodiments described herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1-48. (canceled)

49. A coated fabric comprising:
a fabric substrate;
an outer fluoropolymer coating on the fabric substrate, the outer fluoropolymer coating comprising perfluoropolymer and a silicone polymer in an amount in a range of about 2 wt % to 30 wt %; and
a layer of a silicone polymer deposited on the outer fluoropolymer coating.

50. The coated fabric of claim 49 in which the outer fluoropolymer coating has a surface energy of at least 30 mN/m.

51. The coated fabric of claim 49 further comprising a layer of a primer deposited on the outer fluoropolymer coating and underneath the silicone adhesive layer.

52. The coated fabric of claim 49 wherein the fabric substrate comprises a glass fabric.

53. The coated fabric of claim 49 further comprising a neat fluoropolymer coating on the fabric and underneath the outer coating.

54. The coated fabric of claim 49 in which the coated fabric further comprises a cast PTFE film on the fabric face opposite the outer fluoropolymer coating.

55. The coated fabric of claim 49 wherein the coated fabric has a coefficient of friction of not greater than 0.2.

56. The coated fabric of claim 49 wherein the total weight of the coated fabric is at least 4.0 osy.

57. The coated fabric of claim 49 wherein when the coated fabric is tested by a webbing test, the distance between tear position for the fabric and the tear position for the adhesive is 0.75 inches or less.

58. The coated fabric of claim 49 in which the outer fluoropolymer coating is not etched before the adhesive layer is deposited.

59. The coated fabric of claim 49 in which the outer fluoropolymer coating is not treated by applying colloidal silica suspended in a melt processable fluoropolymer before the adhesive layer is deposited.

60. The coated fabric of claim 49 in which the outer fluoropolymer coating comprises perfluoropolymer and a silicone polymer, the silicone polymer being a condensation polymerized silicone or being derived from a precured silicone polymer dispersion.

61. The coated fabric of claim 49 wherein the adhesion between the adhesive layer and the outer fluoropolymer coating is at least 1.8 lb/in.

62. The coated fabric of claim 49 in which the adhesion between the adhesive and the outer fluoropolymer coating is not damaged by UV light.

63. A coated fabric comprising:
a fabric substrate;
an outer fluoropolymer coating on the fabric substrate, the outer fluoropolymer coating comprising perfluoropolymer and a silicone polymer blend having a surface energy of at least 30 mN/m; and
a layer of a silicone polymer deposited on the outer fluoropolymer coating.

64. The coated fabric of claim 63 wherein the the outer fluoropolymer coating comprises a silicone polymer in an amount in a range of 10 wt % to 25 wt %.

65. A method of forming a coated fabric, the method comprising:
dispensing a fabric;
applying an emulsion coating over the fabric, the emulsion comprising a blend of perfluoropolymer and silicone polymer in an amount in a range of 2 wt % to 30 wt %, and fusing the emulsion coating to form an outer fluoropolymer layer; and
applying an adhesive layer over the outer fluoropolymer layer.

66. The method of claim 65 in which the blend of perfluoropolymer and silicone polymer has a surface energy of at least 30 mN/m.

67. The method of claim 65 in which the emulsion coating is not etched before the adhesive layer is deposited.

68. The method of claim 65 in which the emulsion coating is not treated by applying colloidal silica suspended in a melt proces sable fluoropolymer before the adhesive layer is deposited.
